(19) United States
(12) Patent Application Publication
(10) Pub. No.: US 2018/0124698 A1
(43) Pub. Date: May 3, 2018

(54) COMMUNICATION DEVICE AND IMAGE FORMING APPARATUS

(71) Applicant: KYOCERA Document Solutions Inc., Osaka (JP)

(72) Inventor: Tomoyuki KITAO, Osaka-shi (JP)

(73) Assignee: KYOCERA Document Solutions Inc., Osaka (JP)

(21) Appl. No.: 15/784,304

(22) Filed: Oct. 16, 2017

(30) Foreign Application Priority Data
Oct. 31, 2016 (JP) 2016-203329

(51) Int. Cl. H04W 48/20; H04W 92/10; G06F 3/12; G06F 3/048

(52) U.S. Cl. CPC H04W 48/20; G06F 3/048; G06F 3/1236; H04W 92/10

(57) ABSTRACT

A communication device includes a communication section, an operation display section, and a controller. The communication section accesses a network via an access point. The operation display section displays at least one access point connectable with the communication section as at least one candidate access point, and receives a designation operation of designating an access point from among the at least one candidate access point. The controller connects the communication section with the designated access point. The controller causes the operation display section to receive a condition setting operation of setting a search condition. When receiving the condition setting operation, the controller searches for access points that satisfy the search condition set by the condition setting operation, and causes the operation display section to display at least one access point found by the search as the at least one candidate access point.

### INCORPORATION BY REFERENCE

The present application claims priority under 35 U.S.C. § 119 to Japanese Patent Application No. 2016-203329, filed on Oct. 17, 2016. The contents of this application are incorporated herein by reference in their entirety.

### BACKGROUND

The present disclosure relates to a communication device that is capable of accessing a network formed by a wireless local area network (LAN), and an image forming apparatus.

In recent years, communication devices having a wireless LAN function have been increasing along with popularization of the wireless LAN. A communication device having the wireless LAN function accesses a network via a wireless LAN access point (hereinafter referred to as AP).

For example, a communication device (printing device) detects at least one AP located in a network. Specifically, the communication device detects each AP on the basis of a beacon signal emitted from the AP. The communication device presents at least one detected AP (identifier of the AP) to a user. The user selects an AP from among the at least one AP presented by the communication device. The communication device receives the selection of the AP desired by the user, and connects with the AP selected by the user (accesses the network in which the AP is located).

### SUMMARY

A communication device according to the present disclosure includes a communication section, an operation display section, and a controller. The communication section connects with an access point using wireless local area network communication, and accesses a network via the access point. The operation display section displays at least one access point connectable with the communication section as at least one candidate access point. The operation display section receives a designation operation of designating an access point from among the at least one candidate access point. The controller connects the communication section with the access point designated by the designation operation. The controller causes the operation display section to receive a condition setting operation of setting a search condition for searching for access points to be displayed as the at least one candidate access point. When the operation display section receives the condition setting operation, the controller searches for access points that satisfy the search condition set by the condition setting operation. The controller causes the operation display section to display at least one access point found by the search as the at least one candidate access point.

An image forming apparatus according to the present disclosure includes the above-described communication device.

### BRIEF DESCRIPTION OF THE DRAWINGS

FIG. 1 is a diagram illustrating configuration of a multifunction peripheral according to an embodiment of the present disclosure.

FIG. 2 is a flowchart for explaining a flow of communication establishment processing performed by the multifunction peripheral according to the embodiment of the present disclosure.

FIG. 3 is a diagram illustrating a network setting screen displayed by the multifunction peripheral according to the embodiment of the present disclosure.

FIG. 4 is a diagram illustrating a detailed search screen displayed by the multifunction peripheral according to the embodiment of the present disclosure.

FIG. 5 is a diagram illustrating a detailed search screen displayed by the multifunction peripheral according to the embodiment of the present disclosure.

FIG. 6 is a diagram illustrating a detailed search screen displayed by the multifunction peripheral according to the embodiment of the present disclosure.

FIG. 7 is a diagram illustrating a detailed search screen displayed by the multifunction peripheral according to the embodiment of the present disclosure.

FIG. 8 is a diagram illustrating the network setting screen displayed by the multifunction peripheral according to the embodiment of the present disclosure.

FIG. 9 is a diagram illustrating the network setting screen displayed by the multifunction peripheral according to the embodiment of the present disclosure.

### DETAILED DESCRIPTION

The following describes an image forming apparatus including a communication device according to an embodiment of the present disclosure. In the present embodiment, the image forming apparatus is a multifunction peripheral having a function of performing communication via a wireless LAN. In the following description, the function of performing communication via a wireless LAN may be referred to as a “wireless LAN function”.

### <Configuration of Multifunction Peripheral>

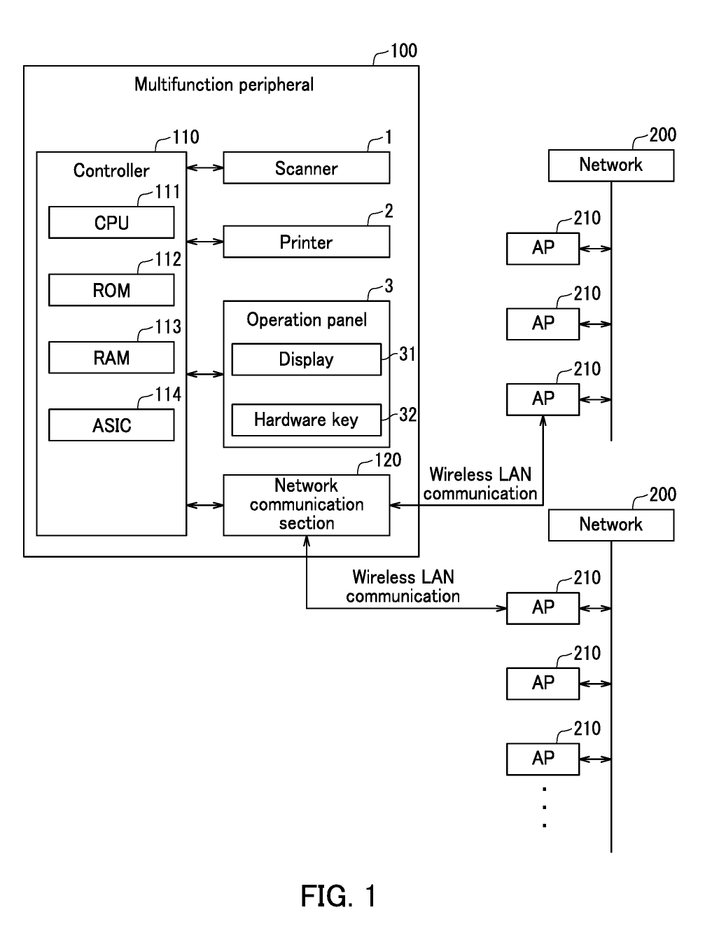

As illustrated in FIG. 1, a multifunction peripheral 100 in the present embodiment includes a scanner 1, a printer 2, and an operation panel 3 (corresponding to an “operation display section”). The scanner 1 reads an image of a document and generates image data of the document. The scanner 1 includes for example a light source, a carriage, an optical system, and a charge-coupled device (CCD) image sensor. The printer 2 forms a toner image on paper on the basis of image data (for example, the image data of the document generated by the scanner 1). The printer 2 includes for example a light exposure device, a charger, a photosensitive drum, a developing device, and a transfer device, and forms the image on the paper by an electrophotographic method. Note that the printer 2 may form the image on the paper by an inkjet method.

The operation panel 3 is for example a touch panel. The operation panel 3 includes a display 31. The display 31 displays a screen in which software keys or the like are arranged. The display 31 receives a touch operation performed by a user on the screen (software key). The operation panel 3 further includes plural types of hardware keys 32 such as a start key for receiving a job execution instruction from the user.

A controller 110 connects with the scanner 1, the printer 2, and the operation panel 3. The controller 110 controls a reading operation of the scanner 1 and a printing operation of the printer 2. Also, the controller 110 detects an operation performed on the operation panel 3 (for example, a touch operation on the display 31 or a pressing operation on the hardware key 32) and executes processing on the basis of the detected operation.

The controller 110 includes a CPU 111, a ROM device 112, a RAM device 113, and an application specific integrated circuit (ASIC) 114. The ROM device 112 stores therein programs and data necessary for controlling the multifunction peripheral 100. The RAM device 113 is used for development of the programs and the data necessary for controlling the multifunction peripheral 10X). The CPU 111 operates on the basis of control programs and data and executes various processing. The ASIC 114 executes for example a part or the entirety of specific processing, such as image processing or communication processing, by means of hardware.

Also, the multifunction peripheral 100 includes a network communication section 120 (corresponding to a “communication section”). The network communication section 120 is a communication device for accessing a network 200. The network communication section 120 connects with the controller 110. The controller 110 controls communication (access to the network 200) performed through the network communication section 120.

The network 200 in the present embodiment is formed by a wireless LAN. The network communication section 120 performs communication via the wireless LAN. The network communication section 120 includes a radio communication device such as a wireless LAN board. The network communication section 120 connects with an access point 210 (hereinafter referred to as an AP 210) by wireless LAN communication. The network communication section 120 accesses the network 200 via the connected AP 210 when receiving an instruction from the controller 110. The network 200 includes for example a personal computer used by the user of the multifunction peripheral 100.

In the present embodiment, the network communication section 120 is capable of accessing a plurality of networks 20X). Each network 200 includes a plurality of APs 210.

### <Search for AP>

The multifunction peripheral 100 is capable of using the wireless LAN function by enabling the wireless LAN function (turning on the wireless LAN function). Settings about the wireless LAN function are received for example by the operation panel 3.

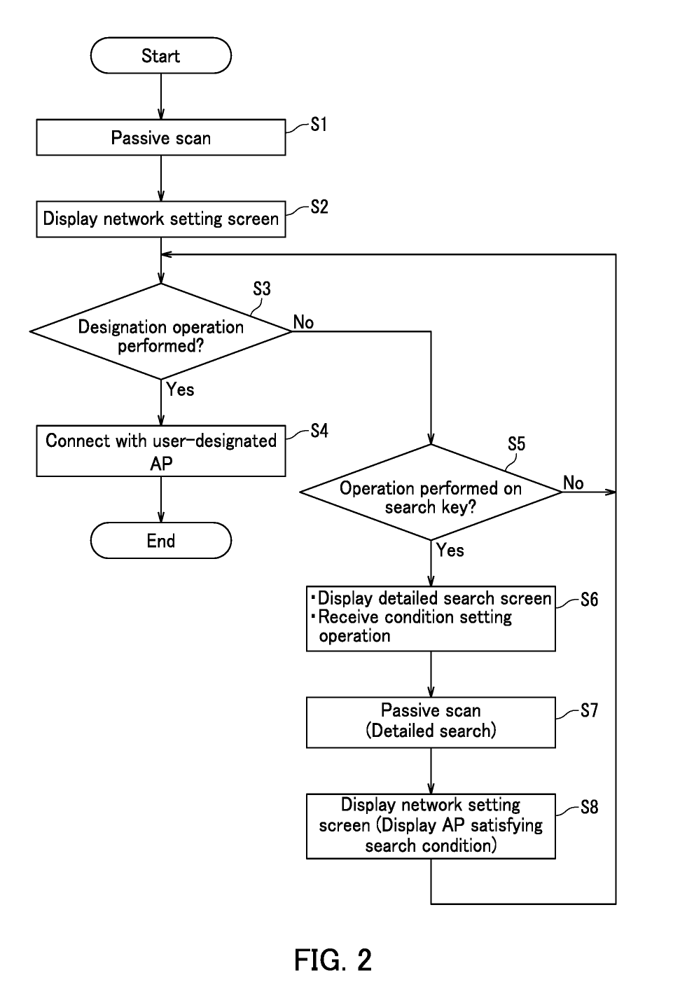

When a setting for enabling the wireless LAN function is received by the operation panel 3, the controller 110 executes communication establishment processing. The communication establishment processing refers to processing for connecting the network communication section 120 with an AP 210 designated by the user. The following describes the communication establishment processing performed by the controller 110 with reference to a flowchart illustrated in FIG. 2. The communication establishment processing starts when the controller 110 detects an operation for enabling the wireless LAN function being performed on the operation panel 3.

At step S1, the controller 110 detects at least one AP 210 connectable with the network communication section 120. In the present embodiment, the controller 110 performs a passive scan for a predetermined time. Specifically, the controller 110 receives a beacon signal broadcasted by each AP 210 through the network communication section 120.

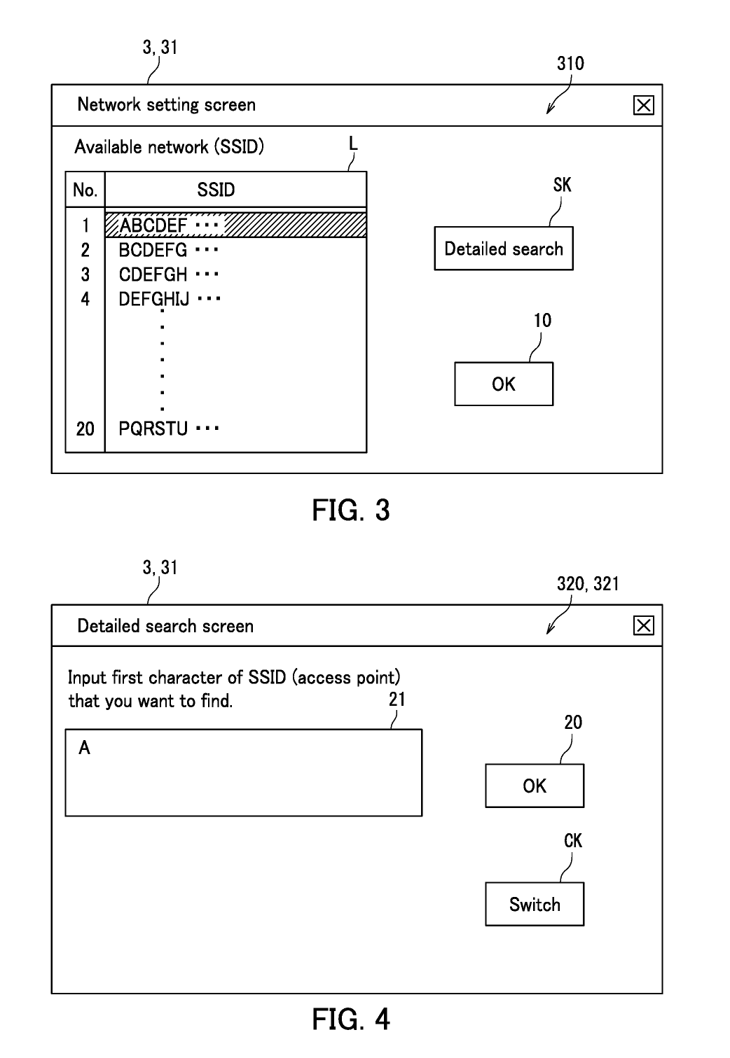

At step S2, the controller 110 causes the operation panel 3 (display 31) to display a network setting screen 310 illustrated in FIG. 3. The network setting screen 310 displays at least one AP 210 detected by the controller 110 each as a candidate AP. The network setting screen 310 receives a designation operation of designating an access point (AP 210) desired by the user from among the at least AP 210 each displayed as a candidate AP.

When detecting the at least one AP 210, the controller 110 lists the at least one AP 210 each as a candidate AP in order of the detection, and assign a number (sequence number) to each AP 210 in order of the detection. The controller 110 causes the operation panel 3 to display a candidate list L. The candidate list L is a list of the at least one AP 210 each detected as a candidate AP. The candidate list L includes the at least AP 210 and the number assigned to each AP 210.

In the present embodiment, the controller 110 recognizes a service set identifier (SSID) of each AP 210 on the basis of a beacon signal received by the network communication section 120 from the AP 210. The controller 110 causes the operation panel 3 to display as the candidate list L a list in which the recognized SSID of each AP 210 is arranged in order of the sequence number. In the example illustrated in FIG. 3, the SSID of each AP 210 is represented as a string of alphabetic characters.

Note that in a situation in which the number of detected APs 210 exceeds a predetermined upper limit number (the upper limit number is for example “20”), the number of APs displayed as candidate APs by the operation panel 3 under control by the controller 110 is the upper limit number. That is, the number of APs 210 displayed as candidate APs in the network setting screen 310 is not larger than the upper limit number.

When the network setting screen 310 is displayed, the communication establishment processing proceeds to step S3. When the communication establishment processing proceeds to step S3, the controller 110 determines whether or not a designation operation of designating an AP 210 (SSID) from the candidate list L is performed on the operation panel 3. For example, the controller 110 determines whether or not a touch operation is performed on a display area of an AP 210 included in the candidate list L. When determining that a touch operation is performed on a display area of an AP 210 included in the candidate list L, the controller 110 detects the touch operation as the designation operation and recognizes the AP 210 displayed in the display area on which the touch operation is performed as a user-designated AP 210. When the controller 110 recognizes the user-designated AP 210, for example color inversion is performed on the display area of the user-designated AP 210 (as illustrated in FIG. 3).

When the controller 110 determines at step S3 that the designation operation is performed on the operation panel 3 (network setting screen 310), the communication establishment processing proceeds to step S4. When the communication establishment processing proceeds to step S4, the controller 110 connects the network communication section 120 with the user-designated AP 210.

When a touch operation is performed on an OK key 10 (see FIG. 3) in the network setting screen 310 subsequently to the designation operation on the operation panel 3, the controller 110 causes the operation panel 3 to display a screen (not illustrated) for inputting a key code assigned to the user-designated AP 210. The controller 110 performs processing for connecting the network communication section 120 with the user-designated AP 210 using the key code input through the operation panel 3. Note that in a situation in which the user inputs a wrong key code or the user does not input any key code, the network communication section 120 is unable to connect with the user-designated AP 210 and the user is unable to use the designated AP 210.

When the controller 110 determines at step S3 that the designation operation is not performed on the operation panel 3, the communication establishment processing proceeds to step S5. When the communication establishment processing proceeds to step S5, the controller 110 determines whether or not a touch operation is performed on a search key SK (see FIG. 3) in the network setting screen 310. When the controller 110 determines that the touch operation is performed on the search key SK, the communication establishment processing proceeds to step S6. By contrast, when the controller 110 determines that the touch operation is not performed on the search key SK, the communication establishment processing returns to step S3.

When the communication establishment processing proceeds to step S6, the controller 110 causes the operation panel 3 to display a detailed search screen 320 as illustrated in FIGS. 4 to 7. The detailed search screen 320 receives a condition setting operation of setting a search condition for searching for an AP 210 desired by the user. The condition setting operation includes a first condition setting operation, a second condition setting operation, a third condition setting operation, and a fourth condition setting operation. The detailed search screen 320 and the condition setting operation will be described further below in detail.

When the search condition is set, the communication establishment processing proceeds to step S7. When the communication establishment processing proceeds to step S7, the controller 110 performs a search (detailed search) for APs 120 that satisfy the search condition. Specifically, the controller 110 performs a passive scan and determines for each AP 210 broadcasting a beacon signal (beacon signal received by the network communication section 120) whether or not the AP 210 satisfies the search condition.

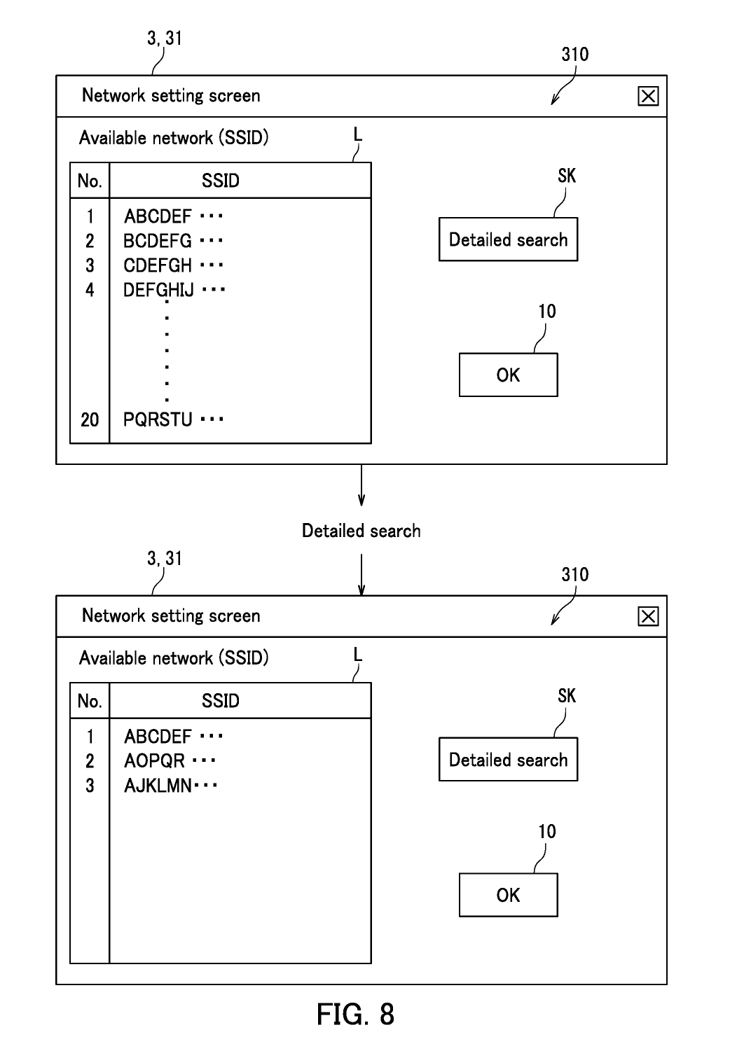

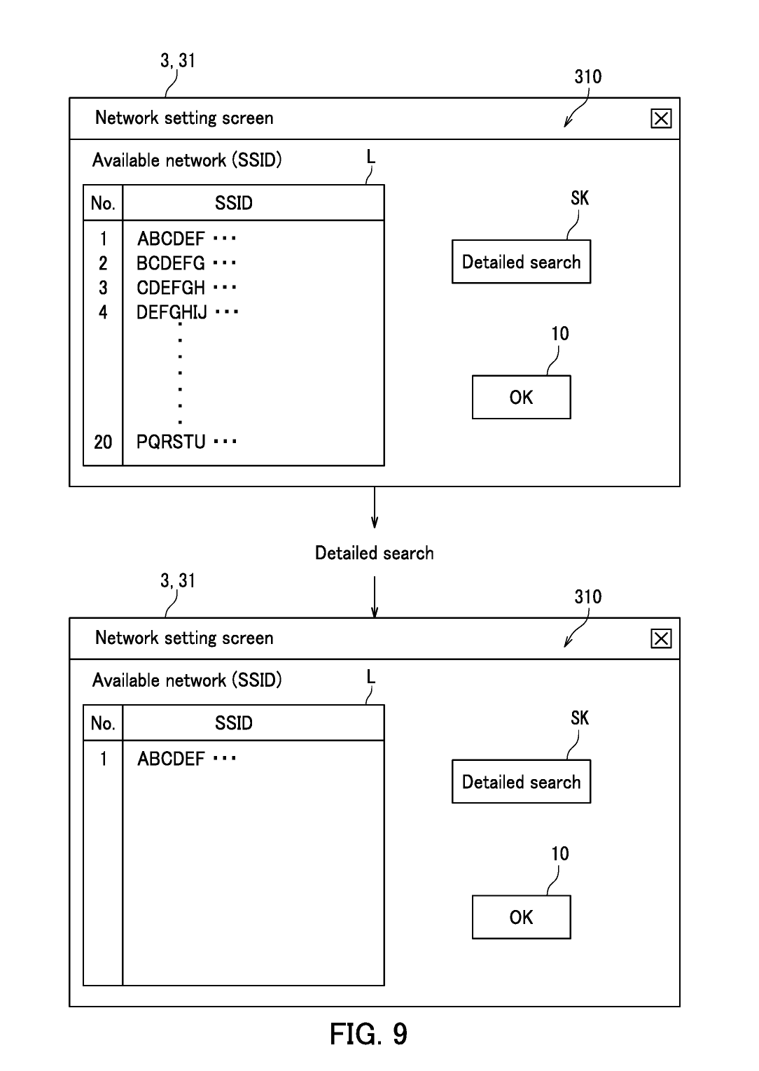

At step S8, the controller 110 lists APs 210 that satisfy the search condition as candidate APs, assigns sequence numbers to the APs 210, and causes the operation panel 3 to display the network setting screen 310. At this time, the operation panel 3 displays only the APs 210 (SSIDs) that satisfy the search condition as the candidate APs. Therefore, as illustrated in FIGS. 8 and 9, the number of the candidate APs displayed in the network setting screen 310 at this time (after the detailed search) is smaller than the number of candidate APs displayed in the network setting screen 310 at the previous time (before the detailed search).

Thereafter, when the communication establishment processing returns to step S3, the controller 110 determines whether or not the designation operation of designating an AP 210 (SSID) from the candidate list L is performed on the operation panel 3. Here, similarly to the network setting screen 310 displayed at the previous time, the network setting screen 310 displayed at this time includes the search key SK. When determining that a touch operation is performed on the search key SK, the controller 110 causes the operation panel 3 to display the detailed search screen 320 and performs a detailed search again on the basis of a search condition newly set by a condition setting operation performed on the displayed detailed search screen 320.

Next, the following describes the detailed search screen 320 (each of 321, 322, 323, and 324) with reference to FIGS. 4 to 7. The detailed search screen 320 (each of 321, 322, 323, and 324) receives a condition setting operation (one of the first through fourth condition setting operations) performed by the user.

The detailed search screen 321 illustrated in FIG. 4 is a screen for receiving the first condition setting operation. The first condition setting operation refers to an operation of inputting the first character (operation of inputting a single character) of an SSID desired by the user. As illustrated in FIG. 4, when the user inputs a single character in an input field 21 of the detailed search screen 321, the input character is displayed in the input field 21. FIG. 4 illustrates as an example a state in which a character “A” is input.

When a touch operation is performed on the OK key 20 after the input of the single character in the input field 21, the controller 110 causes the operation panel 3 to display, as candidate APs, APs 210 each having an SSID that starts from the character input by the first condition setting operation. For example, when the character “A” is input, APs 210 each having an SSID that starts from the character “A” are displayed as candidate APs by the operation panel 3 as illustrated in the lower diagram in FIG. 8.

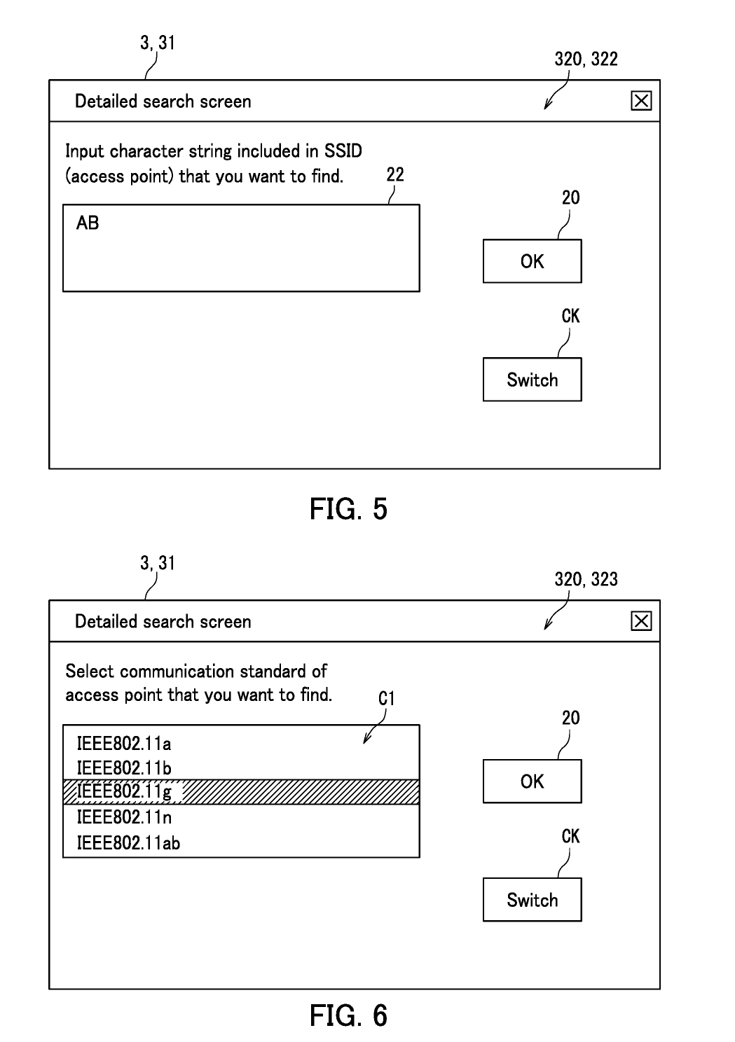

The detailed search screen 322 illustrated in FIG. 5 is a screen for receiving the second condition setting operation. The second condition setting operation refers to an operation of inputting a character string included in an SSID desired by the user. When the user inputs the character string in an input field 22 of the detailed search screen 322, the input character string is displayed in the input field 22. FIG. 5 illustrates as an example a state in which a character string “AB” is input. Note that the number of characters of the character string that can be input in the input field 22 of the detailed search screen 322 is not particularly limited. A character string including two or more characters may be input in the input field 22.

When a touch operation is performed on the OK key 20 after the input of the character string in the input field 22, the controller 110 causes the operation panel 3 to display, as candidate APs, APs 210 each having an SSID including the character string input by the second condition setting operation. For example, when the character string “AB” is input, APs 210 each having an SSID including the character string “AB” are displayed as candidate APs by the operation panel 3 as illustrated the lower diagram in FIG. 9.

The detailed search screen 323 illustrated in FIG. 6 is a screen for receiving the third condition setting operation. The third condition setting operation refers to an operation of inputting (selecting) a communication standard (IEEE802.11a, IEEE802.11b, IEEE802.11g, IEEE802.11n, or IEEE802.11ac) desired by the user. Specifically, the detailed search screen 323 includes a first choice C1 presenting a plurality of communication standards. The third condition setting operation refers to an operation of selecting a communication standard (touching a display area of the communication standard) desired by the user from among the plurality of communication standards presented by the first choice C1. For example, color inversion is performed on the display area of the communication standard selected by the third condition setting operation. When a touch operation is performed on the OK key 20 after the selection of the communication standard in the detailed search screen 323, the controller 110 causes the operation panel 3 to display, as candidate APs, APs 210 that each perform communication in accordance with the communication standard input (selected) by the third condition setting operation though not illustrated.

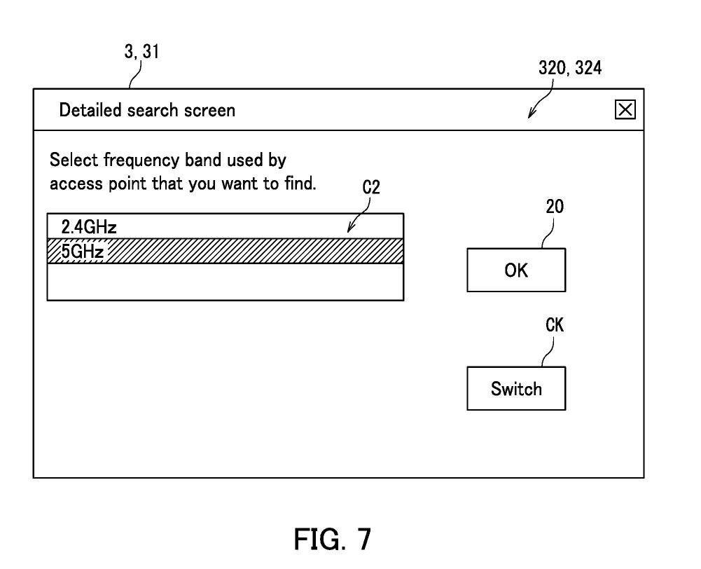

The detailed search screen 324 illustrated in FIG. 7 is a screen for receiving the fourth condition setting operation. The fourth condition setting operation refers to an operation of inputting a frequency band (2.4 GHz or 5 GHz) desired by the user. Specifically, the detailed search screen 324 includes a second choice C2 presenting a plurality of frequency bands. The fourth condition setting operation refers to an operation of selecting a frequency band (touching a display area of the frequency band) desired by the user from among the plurality of frequency bands presented by the second choice C2. For example, color inversion is performed on the display area of the frequency band selected by the fourth condition setting operation. When a touch operation is performed on the OK key 20 after the selection of the frequency band in the detailed search screen 324, the controller 110 causes the operation panel 3 to display, as candidate APs, APs 210 that each perform communication using the frequency band input (selected) by the fourth condition setting operation though not illustrated.

Note that each detailed search screen 320 includes a switch key CK. When detecting a touch operation on the switch key CK, the controller 110 switches the detailed search screen 320 displayed (currently displayed) by the operation panel 3 to another detailed search screen 320.

The multifunction peripheral 100 (communication device, image forming apparatus) according to the present embodiment includes: the network communication section 120 (communication section) that connects with an AP 210 using wireless LAN communication and accesses the network 200 via the AP 210; the operation panel 3 (operation display section) that displays APs 210 connectable with the network communication section 120 as candidate APs, and receives a designation operation of designating an AP 210 from among the candidate APs; and a controller 110 that connects the network communication section 120 with the AP 210 designated by the designation operation. The controller 110 causes the operation panel 3 to receive a condition setting operation of setting a search condition for searching for APs 210 to be displayed as the candidate APs. When the condition setting operation is received by the operation panel 3, the controller 110 searches for APs 210 that satisfy the search condition set by the condition setting operation. The controller 110 causes the operation panel 3 to display APs 210 found by the search as the candidate APs.

According to the configuration of the present embodiment, even in an environment in which the multifunction peripheral 100 is connectable with an extremely large number of APs 210, as a result of the condition setting operation performed by the user on the operation panel 3, the operation panel 3 displays only APs 210 that satisfy a search condition set by the condition setting operation.

Specifically, when an operation of inputting a single character is performed as the condition setting operation, the multifunction peripheral 100 (communication device, image forming apparatus) according to the present embodiment is capable of causing the operation panel 3 to display as candidate APs only APs 210 each having an SSID that starts from the input character. Alternatively, when an operation of inputting a character string is performed as the condition setting operation, the multifunction peripheral 100 (communication device, image forming apparatus) according to the present embodiment is capable of causing the operation panel 3 to display as candidate APs only APs 210 each having an SSID including the input character string.

Alternatively, when an operation of inputting a communication standard is performed as the condition setting operation, the multifunction peripheral 100 (communication device, image forming apparatus) according to the present embodiment is capable of causing the operation panel 3 to display as candidate APs only APs 210 that each perform communication in accordance with the input communication standard.

Further, when an operation of inputting a frequency band is performed as the condition setting operation, the multifunction peripheral 100 (communication device, image forming apparatus) according to the present embodiment is capable of causing the operation panel 3 to display as candidate APs only APs 210 that each perform communication using the input frequency band.

As described above, the user can reduce the number of APs 210 displayed as candidate APs by the operation panel 3 by performing the condition setting operation on the operation panel 3. As a result, the user can easily search for a desired AP 210.

Though not illustrated, when the condition setting operation performed by the user is received, a screen for inputting a value for radio field intensity of the AP 210 may be displayed on the operation panel 3. For example, when the user inputs a value for radio field intensity through the above screen, the operation panel 3 displays as candidate APs, APs 210 each having a value for radio field intensity not smaller than the input value.

Also, in the present embodiment, the operation panel 3 displays the search key SK together with the candidate list L (list of APs 210 detected as candidate APs) in the network setting screen 310 as described above. When a touch operation is performed on the search key SK, the controller 110 causes the operation panel 3 to display the detailed search screen 320 (causes the operation panel 3 to receive the condition setting operation). Therefore, in a situation in which an AP 210 desired by the user is not included in candidate APs displayed in the network setting screen 310 (when the user wants to perform a detailed search), the user can cause the detailed search screen 320 to be displayed by merely performing the touch operation on the search key SK.

It should be noted that all respects of the embodiment disclosed herein are merely examples and are not intended as specific limitations. The scope of the present disclosure is defined by claims not by the above description of the embodiment. Further, the scope of the present disclosure encompasses anything equivalent to what are recited in the claims and every alteration within the scope of the claims.

What is claimed is:

1. A communication device comprising:
a communication section configured to connect with an access point using wireless local area network communication and access a network via the access point;
an operation display section configured to display at least one access point connectable with the communication section as at least one candidate access point, and receive a designation operation of designating an access point from among the at least one candidate access point; and
a controller configured to connect the communication section with the access point designated by the designation operation, wherein
the controller causes the operation display section to receive a condition setting operation of setting a search condition for searching for access points to be displayed as the at least one candidate access point, and
when the condition setting operation is received by the operation display section, the controller searches for access points that satisfy the search condition set by the condition setting operation, and causes the operation display section to display at least one access point found by the search as the at least one candidate access point.

2. The communication device according to claim 1, wherein
the operation display section receives an operation of inputting a single character as the condition setting operation,
when the operation of inputting the single character is received by the operation display section as the condition setting operation, the controller searches for access points each having a service set identifier that starts from the character input by the condition setting operation, and causes the operation display section to display at least one access point found by the search as the at least one candidate access point.

3. The communication device according to claim 1, wherein
the operation display section receives an operation of inputting a character string as the condition setting operation,
when the operation of inputting the character string is received by the operation display section as the condition setting operation, the controller searches for access points each having a service set identifier including the character string input by the condition setting operation, and causes the operation display section to display at least one access point found by the search as the at least one candidate access point.

4. The communication device according to claim 1, wherein
the operation display section receives an operation of inputting a communication standard as the condition setting operation,
when the operation of inputting the communication standard is received by the operation display section as the condition setting operation, the controller searches for access points that each perform communication in accordance with the communication standard input by the condition setting operation, and causes the operation display section to display at least one access point found by the search as the at least one candidate access point.

5. The communication device according to claim 1, wherein
the operation display section receives an operation of inputting a frequency band as the condition setting operation,
when the operation display section receives the operation of inputting the frequency band as the condition setting operation, the controller searches for access points that each perform communication using the frequency band input by the condition setting operation, and causes the operation display section to display at least one access point found by the search as the at least one candidate access point.

6. The communication device according to claim 1, wherein
when displaying the at least one candidate access point, the operation display section displays a search key, and
when an operation is performed on the search key, the controller causes the operation display section to receive the condition setting operation.

7. The communication device according to claim 1, wherein
the controller assigns a sequence number to each of the at least one access point in order of detection thereof, and causes the operation display section to display the at least one access point and the number assigned thereto.

8. An image forming apparatus including the communication device according to claim 1.
